(19) United States
(12) Patent Application Publication
(10) Pub. No.: US 2015/0222435 A1
(43) Pub. Date: Aug. 6, 2015

(54) IDENTITY GENERATION MECHANISM

(71) Applicant: HIGHGATE LABS LIMITED, London (GB)

(72) Inventor: Edward Lea, London (GB)

(21) Appl. No.: 14/417,459

(22) PCT Filed: Jul. 26, 2013
(86) PCT No.: PCT/GB2013/052022

§ 371 Date: Jan. 26, 2015

Related U.S. Application Data
(60) Provisional application No. 61/676,015, filed on Jul. 26, 2012.

(30) Foreign Application Priority Data
Jul. 26, 2012 (GB) 1213279.1

(51) Int. Cl. H04L 9/32; H04L 29/06

(52) U.S. Cl. CPC H04L 9/3213; H04L 63/0884; H04L 9/3226

(57) ABSTRACT

The present invention relates to a method for generating an identity for a user. The method including the steps of: a first user device obtaining an identifier; the first user device generating a public-private key pair; the first user device transmitting a first request, including the identifier and the public key, to a server; the server generating an authentication token associated with the identifier and transmitting that token for receipt by an address associated with the user; the first user device receiving the authentication token via the address of the user; the first user device transmitting a second request, wherein at least a part of the second request is derived from the authentication token and at least a part of the second request is signed by the private key; and the server using the public key to verify the second request and validate the identifier as an identity for the user. A system for generating an identity for a user, and user device and server for use with the system are also disclosed.

### FIELD OF INVENTION

The present invention is in the field of identification. In particular, but not exclusively, the present invention relates to online identity generation for users.

### BACKGROUND

Online identity theft is a common occurrence. Many websites utilise username-password methods for identity verification. Some of these websites have poor security measures and username-password files can be hacked.

Often individuals use the same username (which are frequently email addresses) and password combination across multiple websites. Consequently if one website is hacked, identity verification for those individuals at multiple websites can be compromised.

There is a desire for a new mechanism for identity generation.

Some systems exist which generate a different password for a user for each website. However, these systems require the user to either remember complex, unmemorable passwords or to store the passwords on their devices. Furthermore, it is not possible for a website to enforce the use of these systems by all users.

Websites requiring higher security often use two-factor authentication, where the user is provide with a physical security token. A common security token, used by RSA Security's SecurID system, displays a new number at set intervals. The authentication server for the SecurID system has information about the sequence of numbers and can verify the number entered by the user from the security token.

However, two-factor authentication is often cumbersome for users and requires the user to carry around a physical security token.

It is an object of the present invention to provide an identity generation mechanism which overcomes the disadvantages of the prior art, or at least provides a useful alternative.

### SUMMARY OF INVENTION

According to a first aspect of the invention there is provided a method for generating an identity for a user, including:

a) a first user device obtaining an identifier;
b) the first user device generating a public-private key pair;
c) the first user device transmitting a first request, including the identifier and the public key, to a server;
d) the server generating an authentication token associated with the identifier and transmitting that token for receipt by an address associated with the user;
e) the first user device receiving the authentication token via the address of the user;
f) the first user device transmitting a second request, wherein at least a part of the second request is derived from the authentication token and at least a part of the second request is signed by the private key; and
g) the server using the public key to verify the second request and validate the identifier as an identity for the user.

According to another aspect of the invention there is provided a system for generating an identity for a user including:

a first user device is configured to obtain a identifier, to generate a public-private key pair, to transmit a first request to a server, wherein the first request includes the identifier and the public key, to receive an authentication token via the address of the user, to transmit a second request to the server, wherein at least a part of the second request is derived from the authentication token and at least a part of the second request is signed by the private key; and
a server is configured to generate an authentication token associated with the identifier in response to a first request, to transmit the authentication token for receipt by an address associated with the user in response to the second request, to verify the second request using a public key associated with the second request and, when verified, validating an identifier associated with the second request as an identity for the user.

According to another aspect of the invention there is provided a user device for use in a system for generating an identity for a user, the user device configured to obtain a identifier, to generate a public-private key pair, to transmit a first request to a server, wherein the first request includes the identifier and the public key, to receive an authentication token via the address of the user, to transmit a second request to the server, wherein at least a part of the second request is derived from the authentication token and at least a part of the second request is signed by the private key.

According to another aspect of the invention there is provided a server for use in a system for generating an identity for a user, the server configured to generate an authentication token associated with the identifier in response to a first request from a user device, to transmit the authentication token for receipt by an address associated with the user in response to the second request, to verify the second request using a public key associated with the second request and, when verified, validating an identifier associated with the second request as an identity for the user.

According to another aspect of the invention there is provided a method for generating an identity for a user for use with a processing system, including at least one processor, the method comprising:

a) obtaining an identifier;
b) generating a public/private key pair;
c) transmitting the public key and identifier to a server;
d) receiving a token at an address of the user from the server; and
e) transmitting the token signed with the private key to the server to validate the identity of the user.

According to another aspect of the invention there is provided a method for validating an identity of a user for use with a processing system, including at least one processor, the method comprising:

a) receiving a public key and identifier from a user device;
b) generating a token;
c) associating the token with the public key;
d) transmitting the token to an address of the user;
e) receiving the token signed with the private key from the user device; and
f) verifying the signed token using the public key to validate the identity of the user

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a system in accordance with an embodiment of the invention;

FIG. 2: shows a method in accordance with an embodiment of the invention;

FIG. 3: shows a identity generation method in accordance with an embodiment of the invention; and

FIG. 4: shows a user authentication mechanism using an identity generation method in accordance with an embodiment of the invention.

### DETAILED DESCRIPTION OF PREFERRED EMBODIMENTS

The present invention provides an identity generation mechanism which may be used to enable users to authenticate themselves.

The invention relates to the generation of an identifier (such as a Universally Unique IDentifier—UUID) for a user device (such as a smart phone executing an app).

The identifier can be considered analogous to a username in conventional authentication systems. Rather than using a password, however, the user device signs requests, including the identifier, using a private key. A server storing the public key and identifier can then verify the signature and confirm that the device making the request holds the expected private key for that identifier.

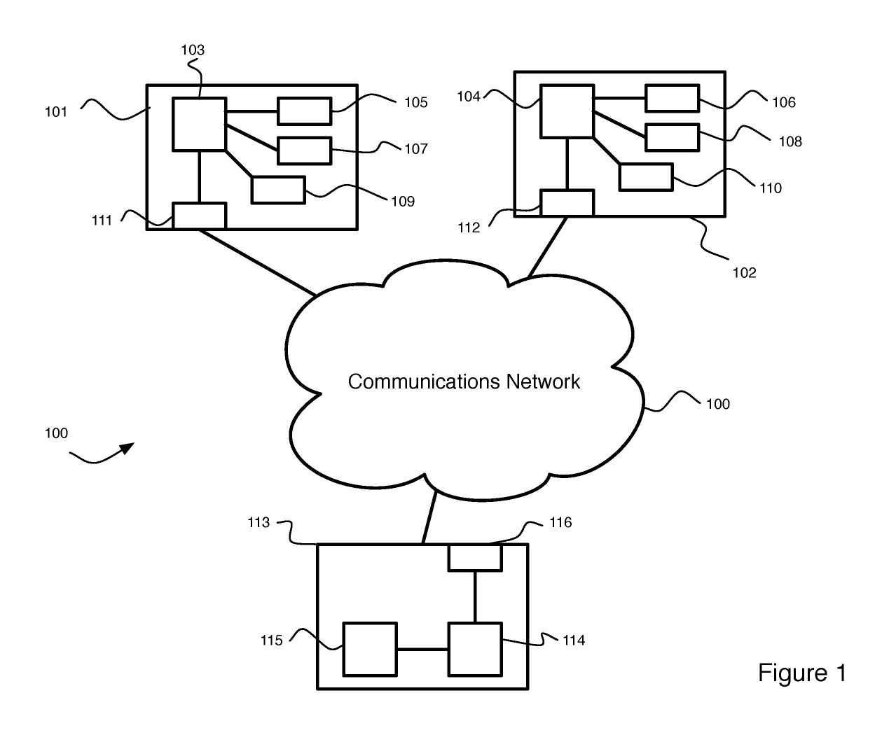

In FIG. 1, a system 100 in accordance with an embodiment of the invention is shown.

The system 100 includes a first user device 101, such as a mobile computing device (i.e. a smart-phone or tablet computer). A second user device 102, such as a computing device (i.e. a computer or laptop) is also shown.

Both user devices 101, 102 may include a processor 103, 104, a memory 105, 106, an input 107, 108, an output 109, 110, and a communications module 111, 112.

The system 100 also includes a server 113. The server 113 may include a processor 114, a memory 115, and a communications module 116.

The first user device 101 is configured to communicate with the server 113. The communication is via a communications network such as mobile Internet.

The second user device 102 may also be configured to communicate with the server 113. The communication may be via a communications network such as the Internet.

The first user device 101 is configured to generate a public/private key pair and may be configured to obtain and/or generate an identifier such as a UUID. The first user device 101 is also configured to receive an authentication token, for example, via an input 107 such as a visual capture device, and to sign a request including the token with the private key for receipt by the server 113.

The server 113 is configured to generate an authentication token and to associate that token with an identifier and public key received from the first user device 101. The server 113 is configured to transmit the token to an address associated with the user. The server 113 is also configured to receive and verify a signed request from the first user device 101 using the received public key.

The second user device 102 may be configured to receive the token and output the authentication token, for example, via a display device 110.

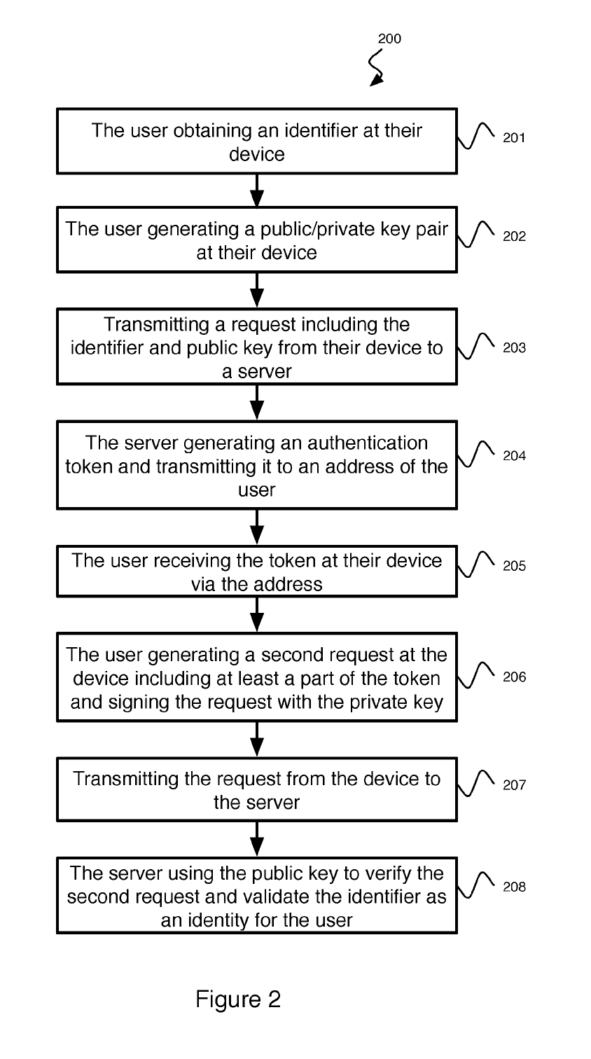

With reference to FIG. 2, a method 200 in accordance with an embodiment of the invention will be described.

The first user device generates a UUID, in step 201, and public/private key pair, in step 202. The UUID and key pairs may be securely stored on the first user device using, for example, a symmetric encryption algorithm. The symmetric encryption algorithm may use a PIN or password as the key.

It will be appreciated that other identifier generating systems could be used, such as GUID (Globally Unique IDentifier), timestamp+a random number, or an incrementing number. In one embodiment, the identifier may be generated at the server and transmitted to the first user device.

The UUID, public key and an email address for the user are transmitted to the server in step 203. The server stores the transmitted information in a database.

In an alternative embodiment, another communication address for the user could be used, such as a telephone number or identifier within another communications platform.

The server generates an authentication token with the UUID and the public key in step 204. The token may be encoded into another format and transmitted to the email address of the user.

The user may open the token within the received email on the first user device. The opened token may be received by an application (for example, a mobile app) on the first user device.

In one embodiment, the authentication token is outputted by the user on a second user device. The authentication token can then be received by the first user device, for example, if the token is displayed on the screen of the second user device by a visual input device (i.e. camera) on the first user device capturing the displayed authentication token. Alternatively, the token could be viewed by the user on the second user device and the token entered manually by the user on the first user device.

The application on the first user device receives the token (and decodes it if encoded) in step 205. The application generates, in step 206, a message, including the UUID and token, signs it with the private key and transmits it to the server in step 207.

The server verifies the signed message using the stored public key in step 208. Once verified, the first user device can now use the UUID and public key as identity authentication in the future using the server.

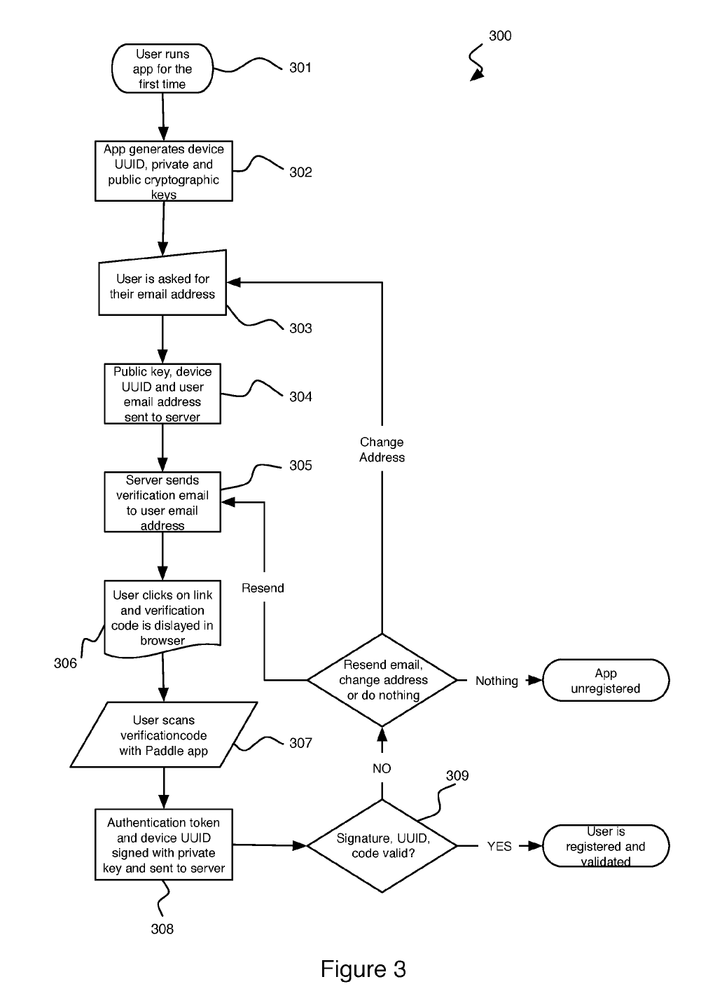

A user identity method 300 of an embodiment of the invention will be described with reference to FIG. 3.

In this system that this method 300 is used within, the first user device is a smart phone and the second user device is a computing device executing a web browser.

The server in this example will be referred to as a Paddle server.

In step 301, the user installs a dedicated app on their smart phone, by downloading from an app store or similar, and executes it for the first time.

In step 302, during first execution, the app initialises in a base-state with no identity information. The app on the first device then generates a UUID and an RSA public/private key pair. These are all stored securely on the first device, preferably using hardware encryption. It will be appreciated that other public/private key systems can be used, such as DSA (Digital Signature Algorithm).

In step 303, the app prompts the user to enter their email address to be associated with the newly created UUID.

In step 304, the UUID, public key and email address are all sent to the Paddle server.

In step 305, all the submitted information is stored in a database and an authentication token is generated on the Paddle server and stored in the database linked to the UUID. In an alternative embodiment, the Paddle server utilises an algorithm to generate the authentication token on demand from the UUID. The Paddle server then sends an email to the provided email address that includes a URL to a validation page that includes the authentication token encoded in a QR code.

In step 306, the user opens the email and loads the URL in their desktop web browser.

In step 307, using the same smart phone app on the same smart phone, the user scans the displayed QR code. The smart phone app decodes the QR and extracts the authentication token.

In step 308, the smart phone app makes a request to the Paddle server; the request including the authentication token and UUID. A hash of the request signed with the private key is also transmitted to the Paddle server.

In step 309, the Paddle server checks that the signature is valid using the public key associated with the UUID; it also checks that the authentication token matches the one generated in step 5. If both match, the system can confirm that the user has full control over the email address provided in step 3, and can thus validate the identity of the user.

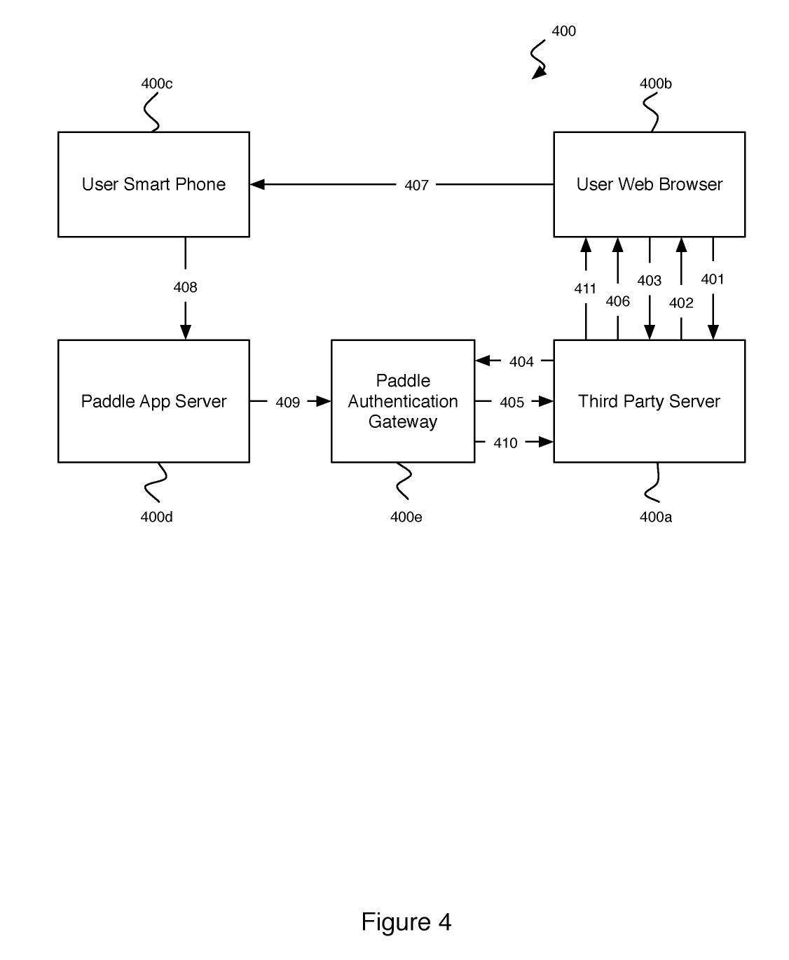

An authentication system and method which uses the identity generation mechanism will now be described with reference to FIG. 4.

In this embodiment, the authentication system 400 will be referred to as Paddle.

The authentication system 400 includes a Paddle client library which may be a Javascript library and which may be stored on a third party server 400a. In alternative embodiments, the Paddle client library is stored on a Paddle application server,

The user is executing a browser on a computing device 400b connected to the Internet. The user also has a smart-phone 400c.

The user may have generated an identity within the system 400 using the identity generation method on their smart-phone 400c described in relation to FIG. 3. In this case, the smart-phone 400c may store a private key which will be used to sign requests and the Paddle application server 400d may store the public key which will be used to verify signed requests. A Paddle authentication gateway 400e may be used to shuttle requests to and from the Paddle application server 400d and the third party server 400a.

In step 401, the user requests a page from third party web server 400a within their browser 400b.

In step 402, the page is returned to the browser 400b, including the Paddle client library and a HTTP session cookie.

In step 403, the user clicks on “Login with Paddle” button displayed within the page in the browser 400b.

In step 404, the third party web server 400a generates a one-time token (a nonce) and sends this and the session cookie information to a Paddle authentication gateway 400e. These details are stored and a unique transaction ID is generated at the gateway 400e. The details may be stored in a database accessible to both the gateway 400e and application server 400d.

In step 405, the Paddle authentication gateway 400e selects a Paddle application server 400d and sends back a URL for a page containing Paddle application server 400d details and transaction ID (for example, the URL points to one of the application servers and has the transaction ID as a path or query string; e.g. https://test.paddle.to/2e0sdf9gkssdf897bsfg).

In step 406, the URL is sent back to the browser 400b and the Paddle client library displays it as an overlay. The Paddle application server sends an HTML page to the browser 400b that includes a QR code with the transaction ID encoded; this is displayed in the overlay.

In step 407, the user scans QR code with a smart phone mobile application (app).

In step 408, the smart phone 400c app makes a signed request, including the transaction ID, to the Paddle application server 400d. The app may extract the address for the Paddle application server 400d from the QR code.

In step 409, the Paddle application server 400d verifies the signature; the request is rejected if the signature is invalid. If it is valid, the email address for this user and the transaction ID is sent back to the Paddle authentication gateway 400e.

In step 410, the Paddle authentication gateway 400e uses the transaction ID to retrieve the stored session details and nonce and sends these, with the user's email address to the third party server 400a.

The third party server 400a verifies the nonce to ensure this request has not been made before and marks the session cookie for this user as authenticated.

In step 411, the web browser 400b is instructed to reload by the Paddle client library and the user sees a “logged in” page.

It will be appreciated that embodiments of the invention described may be implemented in hardware, software, or a combination of hardware and software.

A potential advantage of some embodiments of the present invention is that identity generation for a user can be created securely and efficiently. Other potential advantages of some embodiments of the present invention are that users do not need to remember passwords and brute-force attacks on user accounts (e.g. guessing passwords) are statistically impossible.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for generating an identity for a user, including:
a) a first user device obtaining an identifier;
b) the first user device generating a public-private key pair;
c) the first user device transmitting a first request, including the identifier and the public key, to a server;
d) the server generating an authentication token associated with the identifier and transmitting that token for receipt by an address associated with the user;
e) the first user device receiving the authentication token via the address of the user;
f) the first user device transmitting a second request, wherein at least a part of the second request is derived from the authentication token and at least a part of the second request is signed by the private key; and
g) the server using the public key to verify the second request and validate the identifier as an identity for the user.

2. A method as claimed in claim 1, wherein the identifier is a universally unique identifier (UUID).

3. A method as claimed in claim 1, wherein the first user device obtains the identifier by generating it.

4. A method as claimed in claim 1, further including the step of the server generating the identifier; wherein the first user device obtains the identifier from the server.

5. A method as claimed in claim 1, wherein the signed part of the second request is a signed hash of at least a part of the second request.

6. A method as claimed in claim 1, wherein the second request includes the identifier.

7. A method as claimed in claim 1, wherein the authentication token is encoded.

8. A method as claimed in claim 7, wherein the authentication token is encoded into a QR code.

9. A method as claimed in claim 1, wherein the authentication token is outputted on second user device.

10. A method as claimed in claim 9, wherein the first user device receives the authentication token via the second user device.

11. A method as claimed in claim 10, wherein the first user device receives the authentication token by visual input means.

12. A method as claimed in claim 1, wherein the address is an email address.

13. A method as claimed in claim 1, wherein the first request includes the address.

14. A method as claimed in claim 1, wherein the server stores the public key, authentication token, identifier, and an association between them in a memory.

15. A system for generating an identity for a user including:
a first user device is configured to obtain a identifier, to generate a public-private key pair, to transmit a first request to a server, wherein the first request includes the identifier and the public key, to receive an authentication token via the address of the user, to transmit a second request to the server, wherein at least a part of the second request is derived from the authentication token and at least a part of the second request is signed by the private key; and
a server is configured to generate an authentication token associated with the identifier in response to a first request, to transmit the authentication token for receipt by an address associated with the user in response to the second request, to verify the second request using a public key associated with the second request and, when verified, validating an identifier associated with the second request as an identity for the user.

16. A system as claimed in claim 15, wherein the identifier is a universally unique identifier (UUID).

17. A system as claimed in claim 15, wherein the first user device is further configured to generate the identifier.

18. A system as claimed in claim 15, wherein the server is further configured to generate the identifier and wherein the first user device obtains the identifier from the server.

19. A system as claimed in claim 15, wherein the signed part of the second request is a signed hash of at least a part of the second request.

20. A system as claimed in claim 15, wherein the second request includes the identifier.

21. A system as claimed in claim 15, wherein the authentication token is encoded.

22. A system as claimed in claim 21, wherein the authentication token is encoded into a QR code.

23. A system as claimed in claim 15, wherein a second user device configured to receive the authentication token via the address and to output the authentication token.

24. A system as claimed in claim 23, wherein the first user device receives the authentication token via the second user device.

25. A system as claimed in claim 15, wherein the first user device receives the authentication token by visual input means.

26. A system as claimed in claim 15, wherein the address is an email address.

27. A system as claimed in claim 15, wherein the first request includes the address.

28. A system as claimed in claim 15, wherein the server is configured to store the public key, the authentication token, the identifier, and an association between them in a memory.

29. (canceled)

30. (canceled)

31. (canceled)

32. (canceled)

33. A computer readable storage medium having stored therein a computer program executable on a first user device to generate an identity for a user, the computer program comprising:
code to obtain an identifier;
code to generate a public/private key pair;
code to transmit the public key and identifier to a server;
code to receive a token at an address of the user from the server; and
code to transmit the token signed with the private key to the server to validate the identity of the user.

34. (canceled)
